(19) United States
(12) Patent Application Publication
(10) Pub. No.: US 2008/0133443 A1
(43) Pub. Date: Jun. 5, 2008

(54) Methods and Apparatus for User-Guided Inference of Regular Expressions for Information Extraction

(76) Inventors: Philip L. Bohannon, Cupertino, CA (US); Michael E. Flaster, Tenafly, NJ (US)

Correspondence Address: Ryan, Mason & Lewis, LLP;Suite 205, 1300 Post Road, Fairfield, CT, 06824, US

(21) Appl. No.: 11/565,213

(22) Filed: Nov. 30, 2006

(51) Int. Cl. G06N 5/04

(52) U.S. Cl. 706/48

(57) ABSTRACT

Methods and apparatus are provided for inferring regular expressions that parse and extract information from line-oriented data. A regular expression is generated that matches a line of text by: evaluating a plurality of characters of the line of text to identify one or more domains associated with each of the plurality of characters; assigning a run-length to each of the identified domains; populating a data structure having a data position corresponding to each of the characters with the identified domains and corresponding run-lengths; and generating the regular expression based on the data structure.

### FIELD OF THE INVENTION

The present invention relates to techniques for extracting information from text data sources, and more particularly, to methods and apparatus for inferring regular expressions that parse and extract information from line-oriented data.

### BACKGROUND OF THE INVENTION

A number of tools exist for extracting information from text data sources, such as a web page or another document. Such tools are typically designed to interact with structured data, such as comma-separated files, database tables, or tag-structured data, such as XML. Unfortunately, most real-world data does not naturally exist in this form. While many data sources generate completely unstructured data, such as news articles, a lot of data is well-structured, in that it may be reasonably converted into structured or semi-structured data, but the conversion function or wrapper may not be obvious.

For example, line-oriented files, such as log files, are relatively structured. Line-oriented files are typically parsed using regular expressions. A number of techniques exist for inferring such regular expressions. For example, the Whisk algorithm finds rules about certain types of text, such as classified advertisements and natural language. See, for example, Stephen Soderland, “Learning Information Extraction Rules for Semi-Structured and Free Text,” Machine Learning, V. 34, Nos. 1-3, 233-272 (1999),

In addition, “Potter's Wheel” uses Minimal Description Length (MDL) patterns to infer regular expressions over text. Generally, the MDL principle attempts to encode the sample data compactly. Potter's Wheel provides a set of interactive tools that help transform data from one form to another. In addition, Potter's Wheel has an automatic inference engine that tries to find structure in the input data and then uses this structure to detect outliers, which are likely errors. See, for example, V. Raman and J. M. Hellerstein, “Potter's Wheel: An Interactive Data Cleaning System,” Proc. VLDB 2001, Rome, Italy (2001), downloadable from http://control.cs.berkeley.edu/abc/ and http://control.cs.berkeley.edu/pwheel-vldb.pdf.

A need exists for methods and apparatus for user-guided inference of regular expressions for information extraction. A further need exists for improved methods and apparatus for inference of regular expressions for information extraction where the test data has inter-line similarities and differences that are important cues for pattern inference.

### SUMMARY OF THE INVENTION

Generally, methods and apparatus are provided for inferring regular expressions that parse and extract information from line-oriented data. According to one aspect of the invention, a regular expression is generated that matches a line of text by: evaluating a plurality of characters of the line of text to identify one or more domains associated with each of the plurality of characters; assigning a run-length to each of the identified domains; populating a data structure having a data position corresponding to each of the characters with the identified domains and corresponding run-lengths; and generating the regular expression based on the data structure.

According to another aspect of the invention, a user interface is provided that generates a regular expression that matches a line of text by: evaluating a plurality of characters of the line of text to identify sub-groups of characters that belong to one or more domains; presenting the identified sub-groups of characters to a user for review; allowing the user to adjust the sub-groups of characters using a visual interface; and generating the regular expression based on the adjusted sub-groups of characters.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram illustrating a regular expression interactive editor incorporating features of the present invention;

FIG. 2 is a flow chart describing an exemplary implementation of a regular expression generation process;

FIG. 3 illustrates exemplary pseudo-code for finding the best patterns during step 210 of FIG. 3;

FIG. 4 illustrates exemplary pseudo-code for refining the patterns during step 230 of FIG. 3;

FIG. 5A illustrates an exemplary pattern generation data structure, matchingChoices, for a first embodiment of the pattern generation techniques of the present invention;

FIG. 5B illustrates an exemplary pattern generation data structure, matchingChoices, for a second embodiment of the pattern generation techniques of the present invention;

FIG. 6 illustrates an exemplary screenshot illustrating one embodiment of a user interface;

FIG. 7 illustrates a selection by the user of multiple fields that the user would like to be grouped as a single field;

FIG. 8 is an exemplary user interface illustrating the various options available to a user;

FIG. 9 is an exemplary user interface illustrating the various domains that a user can employ to classify the data; and

FIG. 10 illustrates an exemplary interface containing the exemplary SQL output of the regular expression interactive editor of FIG. 1.

### DETAILED DESCRIPTION

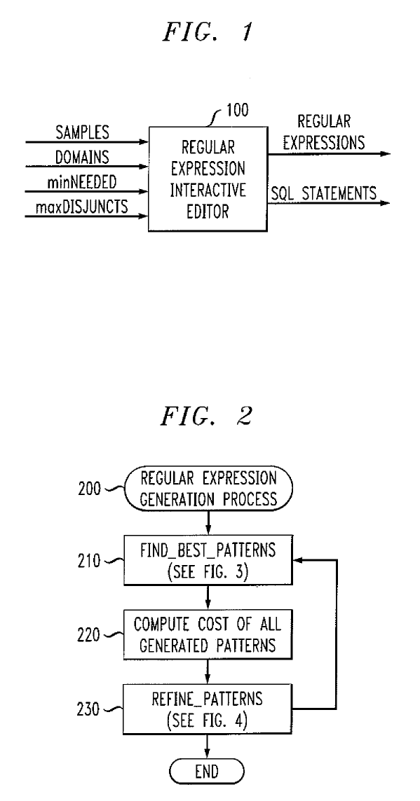

The present invention provides methods and apparatus for user-guided inference of regular expressions for information extraction. As discussed further below in conjunction with FIG. 1, a regular expression interactive editor 100 is disclosed that infers useful regular expressions to parse and extract information from line-oriented data. The regular expression interactive editor 100 provides a user interface that allows the user to modify and guide a regular expression generation process 200, discussed further below in conjunction with FIG. 2. Given text samples, the disclosed regular expression interactive editor 100 automatically computes a regular expression for matching a line of text. Generally, the regular expression interactive editor 100 initially determines a set of regular expressions, and then employs a metric for evaluating the regular expressions, given the sample data.

The regular expressions are obtained by identifying a domain (data type), such as integer, word, space, or punctuation, that matches a prefix of the data sample. Consider the phrase “hello 123”, with domains Anything, Word, Space, and Digits. The phrase may be expressed as any of the following: “Anything+”; “Word+ Anything+”; “Word+ Space+ Anything+”; “Word+ Space+ Digits+”; or “Word+ Space+ Word+”. Consider a sequence of n integers, and assume that the inference engine has a domain library that includes both integers and real values. Each of the numbers in the sequence could be considered either a real value or an integer, leading to 2ⁿ possible patterns to consider. Since n is proportional to the number of characters on a line, the full search space rapidly becomes large.

According to one aspect of the invention, a progressive (depth-limited) search heuristic is employed that breaks the problem into manageable sub-problems. Generally, the progressive search heuristic reduces the search space from cⁿ to c^{(k+n/k)}. Instead of generating all let-to-right regular expressions, the progressive search heuristic initially limits the search to k domains. On subsequent executions, the Anything domains are refined on the subparts of the samples that go with the corresponding Anything part. Consider the sequence of n numbers, which are either integers or real values. As indicated above, there would be 2ⁿ patterns to search with conventional techniques. The first pass yields 2^{k} patterns. All of them will likely end with anything (if k<n). Thereafter, the algorithm is repeated on the text that matches the ‘Anything’ domain, and only the top m choices are taken. This is performed recursively. The progressive search heuristic yields approximately 2^{k}*m^{(n/k)} patterns to search. If 2 equals m, or assuming the base is a constant c, the number of patterns to search is reduced to approximately c^{(k+n/k)}.

According to another aspect of the invention, a greedy parameterization heuristic is employed. Consider the following exemplary lines:

aaa bbb ccc

aaa bcd efg

After an initial evaluation, the pattern “word word word” might be inferred. The first word in the pattern could then be parameterized in two different ways, as the constant “aaa” or any three letter word. Alternatively, the first word can be left alone, and considered to be any word. If this parameterization step considers each word separately, and there are n words, then there are 3ⁿ possible parameterizations to consider. Instead, the present invention considers each parameterization separately and independently, which requires only 3*n choices.

To handle line oriented data in which multiple “types” of lines exist, it is necessary to infer regular expressions with ‘disjuncts’ or the “|” operator. The present invention consider cases in which disjunction appears as the outermost operator, that is “pattern1|pattern2|pattern2”, not “ab (pat1|pat2) cd”. The previous work on expression induction with MDL (Potters Wheel) did not consider inferring disjunctive expressions.

FIG. 1 is a schematic block diagram illustrating a regular expression interactive editor 100 incorporating features of the present invention. As shown in FIG. 1, the regular expression interactive editor 100 processes sample data, a set of domains, and optionally, minNeeded and maxDisjuncts parameters. The samples are a list of strings; the set of domains is a list of data types, such as “integer,” “phone number,” an “real.” The minNeeded parameter rejects a pattern that does not match the specified number (or percentage) of samples; and the maxDisjuncts parameters indicates the number of disjuncts (|'s) allowed in a pattern (i.e., how many different patterns the regular expression interactive editor 100 can generate).

The algorithms performed by the regular expression interactive editor 100 are discussed further below in conjunction with FIGS. 2 through 4. The output of the exemplary regular expression interactive editor 100 are the regular expression and extraction code, such as SQL insert statements, that allow the data samples to be put in a structured table, for example, in a name/value pair format. The generated regular expressions optionally have associated annotations that indicate how to extract portions of the matched data.

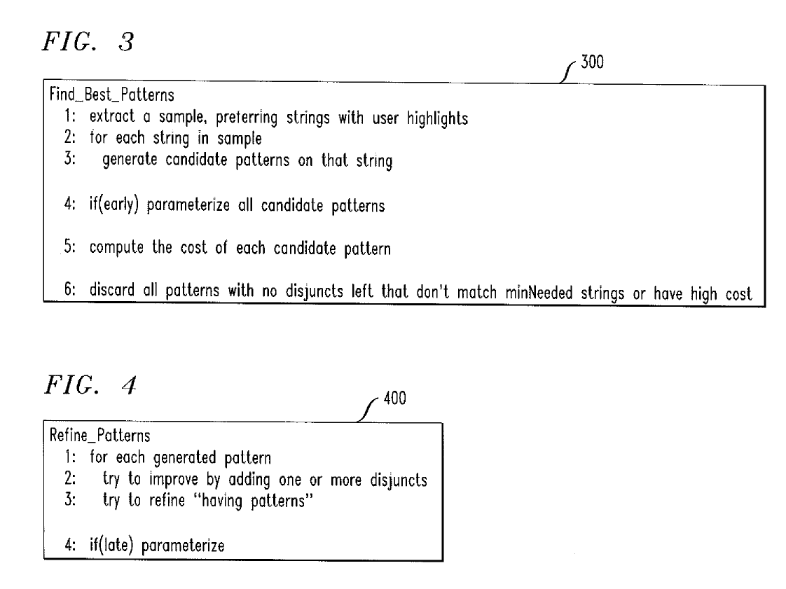

FIG. 2 is a flow chart describing an exemplary implementation of a regular expression generation process 200. As shown in FIG. 2, the regular expression generation process 200 finds the best patterns during step 210, as discussed further below in conjunction with FIG. 3.

Thereafter, during step 220, the regular expression generation process 200 computes the costs of all the patterns computed during step 210. For example, the cost of each pattern may be computed using a Minimal Description Length (MDL) technique. See, for example, P. Grunwald et al. (eds.), Advances in Minimum Description Length: Theory and Applications, M.I.T. Press (MIT Press), April 2005 (ISBN0-262-07262-9). Generally, to compute a minimal description length cost, you consider the number of bits required to code the string. For example, if a string is known to match “(A|B)*”, then clearly only one bit is needed per character, to distinguish the A from the B, while if it matches “(A|B|C|D)”, two bits are needed and so on. However, with the more specific pattern, (A|B)*, there may be samples that don't match, and then you have to pay with a higher cost (the normal 8 bits per letter) for each of these samples.

Finally, during step 230, the regular expression generation process 200 refines the patterns, as discussed further below in conjunction with FIG. 4.

As previously indicated, the regular expression generation process 200 finds the best patterns during step 210. Exemplary pseudo-code 300 for finding the best patterns is shown in FIG. 3. As shown in FIG. 3, a sample is initially extracted from the input data samples during line 1, optionally with a preference for strings having user highlights. Thereafter, for each string in the extracted sample (line 2), the candidate patterns are generated on that string during line 3, in a manner discussed further below in a section entitled “Generating Candidate Patterns.”

In one exemplary embodiment of the invention, the patterns can be parameterized at the beginning (early) or end (late) of the process. Thus, during line 4, a test is performed to determine if the candidate patterns are to be parameterized early. The cost of each candidate pattern is computed during line 5, for example, using the MDL technique referenced above for all generated patterns.

Finally, during line 6, all patterns with no remaining disjuncts are discarded that don't match any minNeeded strings.

As previously indicated, the regular expression generation process 200 refines the patterns during step 230. Exemplary pseudo-code 400 for refining the patterns is shown in FIG. 4. As shown in FIG. 4, for each generated pattern (line 1), the pseudo-code 400 attempts to improve the pattern by adding one or more disjuncts during line 2 and refining the “halving patterns” during line 3, in a manner discussed further below. A test is performed in line 4 to determine if the candidate patterns are to be parameterized late.

### Generating Candidate Patterns

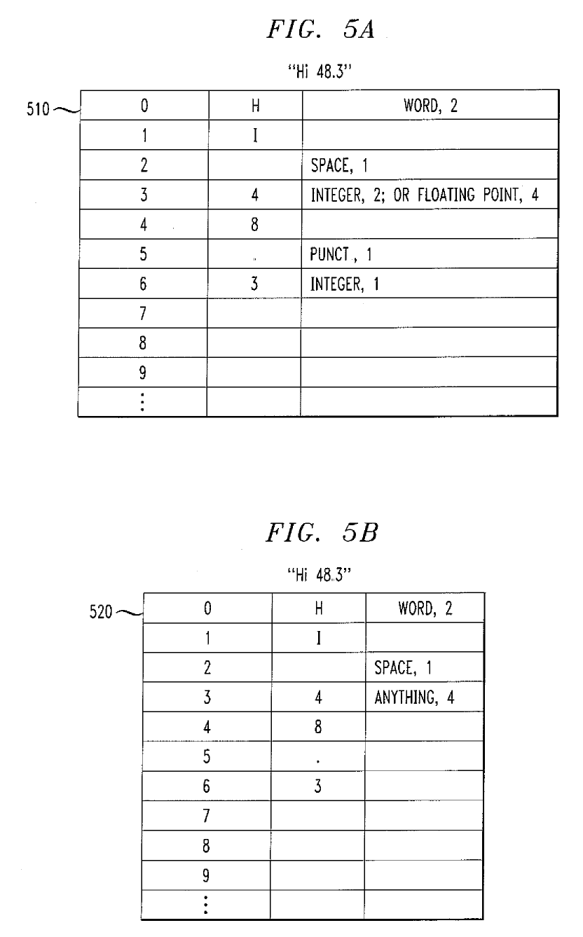

As previously indicated, candidate patterns are generated for each string in the extracted sample during line 3 of the pseudo-code 300 of FIG. 3. In an exemplary embodiment, the generation of candidate patterns depends on a data structure, “matchingChoices.” This structure keeps track of what domains might match at a particular offset in a string. Consider the string “hi 48.3” shown in FIG. 5A. FIG. 5A illustrates the pattern generation data structure, matchingChoices, for a first embodiment of the pattern generation techniques of the present invention. The structure 510, matchingChoices, might record that offset 0 could be matched by a “word” domain, offset 2 by a “space” domain, and offset 3 by either an “integer” domain or a “floating-point” domain. Each position of the structure 510, matchingChoices, records one or more domains that may apply to the current position of the text and the corresponding run-length for that domain. For example, if the first position (“H”) is assigned the Word domain, it will have a run-length of two positions (“Hi”). Likewise, if the fourth position (“4”) is assigned the Integer domain, it will have a run-length of two positions (“48”). Alternatively, if the fourth position (“4”) is assigned the Floating Point domain, it will have a run-length of four positions (“48.3”).

In one exemplary embodiment, the “generate candidate patterns” function fills out the matchingChoices table only for those locations in the string that are of interest. For example, using the exemplary “hi 48.3” string shown in FIG. 5A, the positions offset 1 and offset 4 in the example string are not of interest, since it is not interesting to store the “i” in a separate variable from the “h,” nor the “8” separately from the “4.” Thus, the corresponding positions of the structure 510 are left blank.

The algorithm for populating the structure 510 matches each known domain at the start of the string. If a match is found, the position where the match ends is noted (i.e., the run-length). For example, the string match at the beginning of “hi 48.3” ends at offset 1. Now, if offset 2 is already in the table, then the process is complete, since the table has already been filled out starting at offset 2. Otherwise, the function is recursively called on the rest of the string, say “48.3,” but with the correct offsets to fill the table.

In an exemplary implementation, matching is greedy, so “h” and “i” are not each matched by “word,” since all of “hi” can be matched.

The matchingChoices data structure 510 summarizes a number of patterns that match the sample string. These patterns are returned as the candidate patterns generated by this string.

Optionally, as indicated above, a ‘halving pattern’ can be introduced, once a large part of the string is matched, as discussed further below in a section entitled “Refine Pattern.” The halving pattern matches the rest of the string with a simple “.*” or “match anything” pattern. In this manner, if the first part fails to match many strings, further significant processing is avoided on the second part.

A prioritization scheme can be established for the domains, such that more specific domains are assigned to characters over more general domains. For example, If one domain matches a phone number “999-999-9999” and another matches an integer ‘9*’, then we may want to prioritize the phone number higher than just integer, since the fact that it matches provides significant evidence that the match is correct.

FIG. 5B illustrates the pattern generation data structure, matchingChoices, for a second embodiment of the pattern generation techniques of the present invention, corresponding to the optional“halving pattern” implementation of line 3 of the pseudo code of FIG. 4. Generally, the “halving pattern” implementation allows the user to specify how much of a given line of text to process before replacing the pattern with an “Anything” domain. For example, the “halving pattern” implementation can specify that a certain percentage, such as 50%, of each line of text should be processed. Alternatively, the “halving pattern” implementation can specify that each line of text should be processed until a predefined number of domains have been added to the structure 520. For example, if the “halving pattern” criteria specifies a maximum of five domains should be added to the structure 520, and three possible domains are added for the first character and two possible domains are added for the third character, then the maximum number of domains have been assigned and the fourth character is assigned the “Anything” domain with a run-length that extends to the end of the line of text.

The “Anything” domain that is assigned to the remainder of the text can be updated to one or more actual domains for the remaining characters during an optional refinement stage. See the fourth position of the structure 520 of FIG. 5B where the “Anything” domain is assigned for the remaining four positions of the text (run-length equals 4).

Improve by Adding Disjuncts

As indicated above, an optional maxDisjuncts parameters indicates the number of disjuncts (|'s) allowed in a pattern (i.e., how many different patterns the regular expression interactive editor 100 can generate). To attempt to add additional disjuncts to a pattern being evaluated, the regular expression generation process 200 removes from the input sample set all the sample strings that match the pattern. Thereafter, the regular expression generation process 200 attempts to find a good pattern on the remaining samples, using the techniques described above. This process is repeated until the maximum number of disjuncts is reached, or until the computed cost doesn't decrease.

For example, if there are three allowed disjuncts (maxDisjuncts), and none have been used so far, the score of a pattern being evaluated can be computed as follows. Take the cost for the samples the pattern matches, and divide the computed costs by the maximum number of samples the pattern matches, and n/3 (where n is the number of samples). In other words, it is the cost per match, but it should match at least ⅓ of the samples when there are three disjuncts available.

Refine Patterns

Some domains are not true domains but are designed to match larger sections of text, such as “.*” (match anything) or “anything but a ‘,’”. During an optional refinement stage, the regular expression generation process 200 tries to find a pattern to match the text skipped by these patterns.

Strings do not always begin with a domain pattern, although they typically eventually return to a regular domain pattern. Consider the following data samples:

(abc),

def,

1234,

A pattern generated in the left-to-right manner described above will not be sufficient. Instead, the halving pattern can be employed. The general form of a halving pattern, given some token t, is (.*)t(.+). Furthermore, if it is a single character, the pattern is ([̂t]*)t(.+).

To accomplish this, each line is broken into a set of tokens. The tokens are derived by breaking up each line into the four mutually exclusive (exemplary) domains of Letter+, Digit+, Space+, and Punctuation. The first line would have the following four tokens: “(”, “abc”, “)”, and “,”.

For each token, the path of the domains that precede it is stored. The exemplary process finds tokens that (a) appear on most of the lines, and (b) exhibit at least some variation in domain paths. (If all domain paths are the same, there's no need for a halving pattern.)

The exemplary embodiment considers up to three halving tokens:
bestUniquePaths—this is the token that has the fewest number of unique paths (greater than one) leading up to it. The more regularity preceding a token, the more likely it is that splitting on it is a good idea.
bestAvgLen—this is the token which has on average the smallest number of domains in its paths. The process can split on a token that is close to the beginning.
bestLinesMatched—this is the token that matches the most number of lines. In the case of ties, the average path length is used as a tie breaker.

Often, the three choices for halving tokens will match.

Matching a Sample

To match a sample, it not only has to match like a regular expression would, it has to match each user-highlighted region of the sample with a single domain.

### User Interface

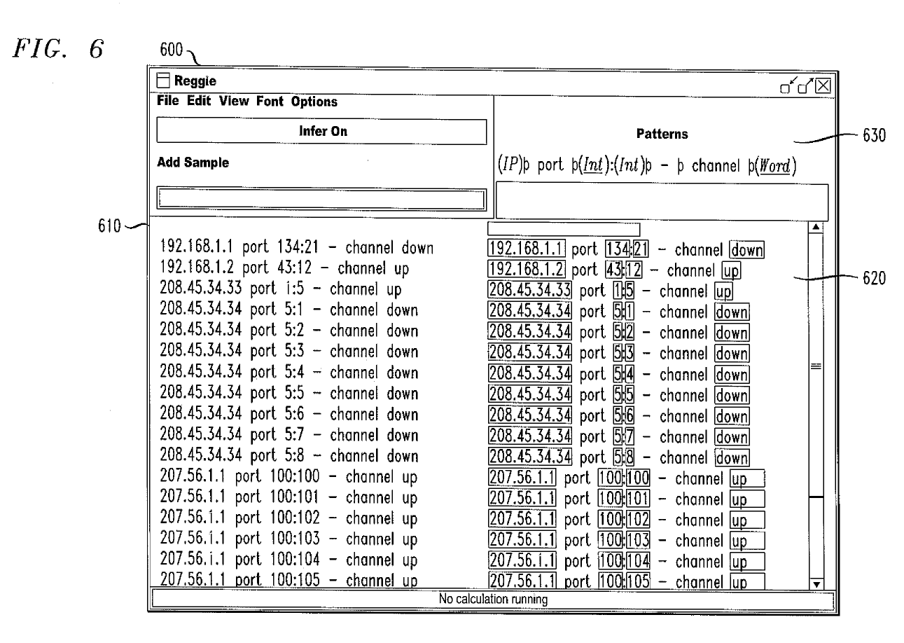

As previously indicated, the regular expression interactive editor 100 provides a user interface that allows the user to modify and guide the inference algorithm. FIG. 6 illustrates an exemplary screenshot illustrating one embodiment of a user interface 600. As shown in FIG. 6, the exemplary interface 600 includes a first window 610 that presents the input samples to the user, a second window 620 for presenting the user with the sample data as grouped according to the proposed patterns generated by the regular expression generation process 200, and a third window 630 for presenting the proposed patterns. In this manner, the regular expression generation process 200 breaks up the input sample data for review by the user.

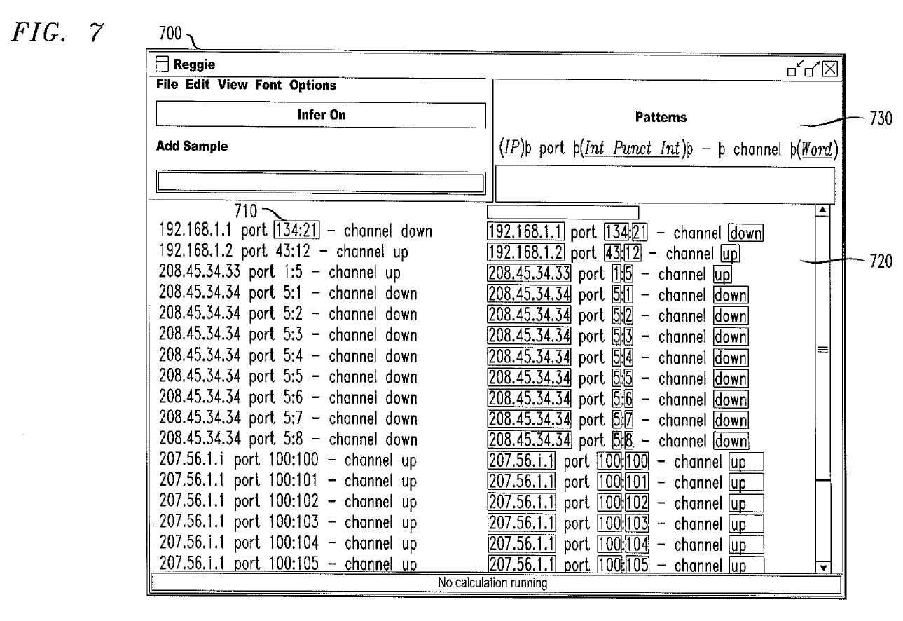

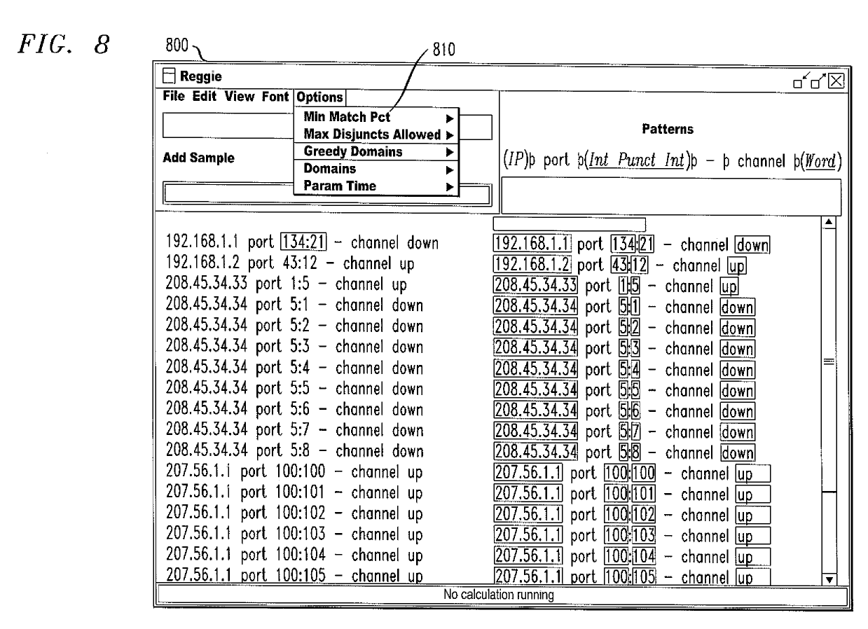

According to one aspect of the invention, the regular expression interactive editor 100 allows the user to select multiple fields from the data in window 610 to be grouped. This process will collapse multiple fields into a single group. FIG. 7 illustrates a selection by the user of multiple fields 710 that the user would like to be grouped as a single field. Note in FIG. 6 that the regular expression interactive editor 100 initially assigned separate domains to the integers 134 and 21 from the first line of text. In FIG. 7, the user has selected these multiple fields to be grouped. Thus, in windows 720 and 730 the two fields are now included in a single group (Int Punct Int). In a further variation, the user can also select the multiple fields 710 (or any highlighted text), for example by right clicking on the selected text, to add a name to the selected text.

In addition, the interface 700 optionally provides a function to allow a user to add or delete groupings from the patterns.

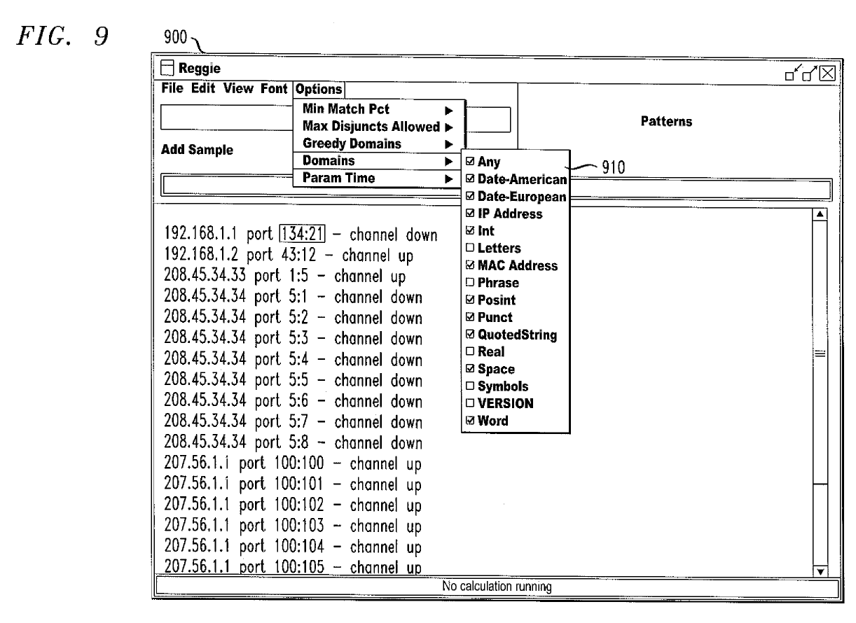

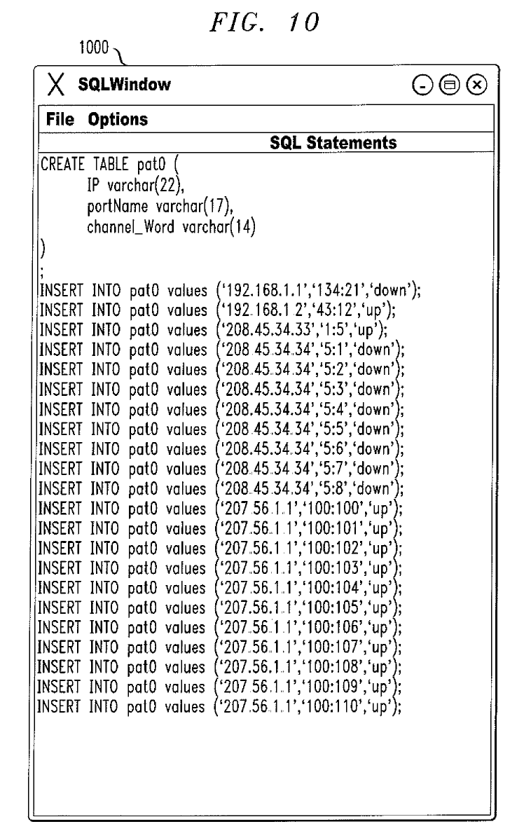

FIG. 8 is an exemplary user interface 800 illustrating the various options 810 available to a user. For example, as previously indicated, the user can optionally specify the minNeeded parameter (Min Match Pct) that rejects a pattern that does not match the specified number (or percentage) of samples. In addition, the user can optionally specify the maxDisjuncts parameters that indicates the number of disjuncts (|'s) allowed in a pattern (i.e., how many different patterns the regular expression interactive editor 100 can generate). The user can also define the greedy domains, the available domains, as discussed further below in conjunction with FIG. 9, and the parameter time.

FIG. 9 is an exemplary user interface 900 illustrating the various domains 910 that a user can employ to classify the data. As shown in FIG. 9, the exemplary embodiment provides a check box for each domain, allowing the user to indicate whether the domain is available. The user can also configure whether the parameterization is performed early or late (Param Time), as shown in the pseudo code of FIGS. 3 and 4.

FIG. 10 illustrates an exemplary interface 1000 containing the exemplary SQL output of the regular expression interactive editor 100. The SQL insert statements shown in FIG. 10 allow the input data samples to be placed in a structured table.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for generating a regular expression that matches a line of text, comprising:
evaluating a plurality of characters of said line of text to identify one or more domains associated with each of said plurality of characters;
assigning a run-length to each of said identified domains;
populating a data structure having a data position corresponding to each of said characters with said identified domains and corresponding run-lengths; and
generating said regular expression based on said data structure.

2. The method of claim 1, further comprising the step of stopping said evaluating step based on a plurality of characters.

3. The method of claim 1, wherein said evaluating step identifies the domains applicable to said plurality of characters based on a prioritization of said domains.

4. The method of claim 1, further comprising the step of generating one or more lines of code that allow information to be extracted from said line of text.

5. The method of claim 1, further comprising the step of generating one or more lines of code that allow information to be extracted from said line of text in a name/value pair format.

6. The method of claim 1, wherein said domains can be specified by a user.

7. A method for generating a regular expression that matches a line of text, comprising:
evaluating a plurality of characters of said line of text to identify one or more domains associated with each of said plurality of characters;
comparing said assigned domains to a plurality of regular expression patterns that have been established, each of said patterns associated with a different disjunct;
generating said regular expression based on said comparing step; and
adding a regular expression pattern for an additional disjunct by removing said lines of text that match said existing plurality of regular expression patterns and determining a regular expression pattern for said remaining lines of text.

8. The method of claim 7, wherein a maximum number of said disjuncts may be specified by a user.

9. A method for generating a regular expression that matches a line of text, comprising:
evaluating a plurality of characters of said line of text to identify sub-groups of characters that belong to one or more domains;
presenting said identified sub-groups of characters to a user for review;
allowing said user to adjust said sub-groups of characters using a visual interface; and
generating said regular expression based on said adjusted sub-groups of characters.

10. The method of claim 9, further comprising the step of stopping said evaluating step based on a plurality of characters.

11. The method of claim 9, wherein said evaluating step identifies the domains applicable to said plurality of characters based on a prioritization of said domains.

12. The method of claim 9, wherein said regular expression allows information to be extracted from said line of text.

13. The method of claim 9, wherein said domains can be specified by a user.

14. A system for generating a regular expression that matches a line of text, comprising:
a memory; and
at least one processor, coupled to the memory, operative to:
evaluate a plurality of characters of said line of text to identify one or more domains associated with each of said plurality of characters;
assign a run-length to each of said identified domains;
populate a data structure having a data position corresponding to each of said characters with said identified domains and corresponding run-lengths; and
generate said regular expression based on said data structure.

15. The system of claim 14, wherein said processor is further configured to stop said evaluating step based on a plurality of characters.

16. The system of claim 14, wherein said processor is further configured to identify the domains applicable to said plurality of characters based on a prioritization of said domains.

17. The system of claim 14, wherein said processor is further configured to generate one or more lines of code that allow information to be extracted from said line of text.

18. The system of claim 14, wherein said processor is further configured to generate one or more lines of code that allow information to be extracted from said line of text in a name/value pair format.

19. A system for generating a regular expression that matches a line of text, comprising:
a memory; and
at least one processor, coupled to the memory, operative to:
evaluate a plurality of characters of said line of text to identify sub-groups of characters that belong to one or more domains;
present said identified sub-groups of characters to a user for review;
allow said user to adjust said sub-groups of characters using a visual interface; and
generate said regular expression based on said adjusted sub-groups of characters.

20. The system of claim 19, wherein said domains can be specified by a user.
